(19) United States
(12) Patent Application Publication
(10) Pub. No.: US 2025/0075914 A1
(43) Pub. Date: Mar. 6, 2025

(54) COOKING APPLIANCE

(71) Applicant: LG ELECTRONICS INC., Seoul (KR)

(72) Inventors: Soochan LEE, Seoul (KR); Kyoung-Joon Park, Seoul (KR); Myeong Jun Shin, Seoul (KR); Hyunwoo Jun, Seoul (KR)

(21) Appl. No.: 18/755,823

(22) Filed: Jun. 27, 2024

(30) Foreign Application Priority Data
Aug. 30, 2023 (KR) 10-2023-0114184
Aug. 30, 2023 (KR) 10-2023-0114185

(51) Int. Cl. F24C 7/08; F24C 7/02

(52) U.S. Cl. CPC F24C 7/085; F24C 7/02

(57) ABSTRACT

Disclosed is an invention related to a cooling appliance. The disclosed invention provides a cooking appliance including a cavity having a cooking chamber formed therein, and a camera disposed outside the cavity, wherein the camera includes a light receiving portion configured to allow light to pass through the inside of the camera, the cavity is formed with an open hole exposing the light receiving portion to the inside of the cooking chamber, and the open hole is formed in a polygonal shape, or surrounded by a protrusion protruding from the cavity.

### CROSS-REFERENCE TO RELATED APPLICATIONS

This application claims priority under 35 U.S.C. § 119 to Korean Application Nos. 10-2023-0114184 and 10-2023-0114185 both filed on Aug. 30, 2023, whose entire disclosures are hereby incorporated by reference.

### BACKGROUND

### 1. Field

The present invention relates to a cooking appliance, and more specifically, to a cooking appliance provided with a camera for capturing the inside of a cooking chamber.

### 2. Background

A cooking appliance is a type of home appliance for cooking food and is a machine installed in a kitchen space to cook food according to a user's intention. The cooking appliance may be classified in any of various ways according to a heat source or type used and the type of fuel.

When classified according to the type of cooking food, the cooking appliance may be classified into open and closed cooking appliances according to the type of a space in which food is placed. The closed cooking appliance includes an oven, a microwave oven, etc., and the open cooking appliance includes a cooktop, a hob, a griddle, etc.

The closed cooking appliance is a cooking appliance that shields the space in which food is located and cooks the food by heating the shielded space. In the closed cooking appliance, a chamber or cooking chamber, which is a space in which food is placed and which is shielded when the food is cooked, is provided inside a main body. The cooking chamber is actually a space in which food is cooked. A heat source is provided in an internal or external space of the cooking chamber to heat the cooking chamber.

Among closed cooking appliances, a microwave oven is a cooking device for generating high frequency waves using electricity to permeate a cooking object accommodated in a cooking chamber and heating the cooking object by causing molecular motion in the cooking chamber.

The microwave oven is a kitchen appliance that simultaneously heats the inside and outside of food by radiating a high frequency waves generated by a magnetron to the food and is widely used because it has advantages that thermal efficiency is high, a cooking time of a cooking object is significantly shortened, loss of an nutritional value can be reduced in a process of cooking, thawing, and warming the cooking object, and the cooking object may be cooked directly in a state of being stored in a container.

Some of the closed cooking appliances may compositely provide functions of an oven and a microwave oven. The closed cooking appliance may be provided with an electric heater provided in the oven and a magnetron provided in the microwave oven, and cooking may be performed by using the heat generated from the electric heater and the high frequency of the magnetron separately or together.

In addition, recently, a closed cooking appliance provided with a built-in camera has been developed. The cooking appliance may acquire images related to food accommodated inside the cooking chamber through the built-in camera. The image acquired by the built-in camera may be used to be displayed through a display provided in the cooking appliance or the user's smart device and may also be used as data for controlling a cooking operation of the cooking appliance.

When the image acquired by the built-in camera is used as the data for controlling the cooking operation of the cooking appliance, the cooking appliance may determine the type of food or the degree of cooking progress of the food by analyzing the food-related image acquired by the built-in camera, and control the cooking operation of the cooking appliance based on the analyzed information.

Typically, the built-in camera is installed in a cavity forming the cooking chamber or in a door disposed at a front side of the cooking chamber. As an example, the built-in camera may be installed on an outer upper portion of the cavity to capture an image of the cooking chamber at the top. As another example, the built-in camera may be installed on the door to capture an image of the cooking chamber at the front side.

When the built-in camera is installed on the outer upper portion of the cavity, as a viewing angle of the built-in camera increases, an image of the food accommodated inside the cooking chamber may be captured. For example, as the size of the food accommodated in the cooking chamber increases and the food is located at the top of the cooking chamber, the viewing angle of the built-in camera may increase, thereby effectively capturing an image of the entirety of the corresponding food.

### BRIEF DESCRIPTION OF THE DRAWINGS

The embodiments will be described in detail with reference to the following drawings in which like reference numerals refer to like elements wherein:

FIG. 1 is a perspective view showing a cooking appliance according to one embodiment of the present invention.

FIG. 2 is a front cross-sectional view showing an internal structure of the cooking appliance shown in FIG. 1.

FIG. 3 is a side cross-sectional view showing the internal structure of the cooking appliance shown in FIG. 1.

FIG. 4 is a plan cross-sectional view showing the internal structure of the cooking appliance shown in FIG. 1.

FIG. 5 is a front cross-sectional view showing an installation structure of a camera module according to one embodiment of the present invention.

FIG. 6 is a plan view schematically showing a shape of an open hole of the cooking appliance according to one embodiment of the present invention.

FIG. 7A-7B is a view for describing an operation of the open hole of the cooking appliance according to one embodiment of the present invention.

FIG. 8 is a front cross-sectional view showing an installation structure of a camera module according to another embodiment of the present invention.

FIG. 9 is a view for describing a structure of a shielding protrusion shown in FIG. 5.

### DETAILED DESCRIPTION

The above-described objects, features, and advantages will be described below in detail with reference to the accompanying drawings, and thus those skilled in the art to which the present invention pertains will be able to easily carry out the technical spirit of the present invention. In describing the present invention, when it is determined that a detailed description of the known technology related to the present invention may unnecessarily obscure the gist of the present invention, a detailed description thereof will be omitted. Hereinafter, exemplary embodiments according to the present invention will be described in detail with reference to the accompanying drawings. In the drawings, the same reference numerals are used to denote the same or similar components.

Although terms such as first and second are used to describe various components, it goes without saying that the components are not limited by these terms. These terms are only used to distinguish one component from another component, and unless otherwise stated, it goes without saying that the first component may be the second component.

The present invention is not limited to the embodiments disclosed below, but may be variously changed and implemented in various different forms. The present embodiment is merely provided to allow the disclosure of the present invention to be complete and fully inform those skilled in the art of the scope of the invention. Therefore, it should be understood that the present invention is not limited to the embodiments disclosed below, but includes not only the substitutions and additions between a configuration of any one embodiment and a configuration of another embodiment, but also all changes, equivalents, and substitutions included in the technical spirit and scope of the present invention.

The accompanying drawings are only for easy understanding of the embodiments disclosed in the specification, and it should be understood that the technical spirit disclosed in the specification is not limited by the accompanying drawings, and all changes, equivalents, or substitutes included in the spirit and technical scope of the present invention are included in the accompanying drawings. In the drawings, components may be expressed exaggeratedly great or small in size or thickness in consideration of better understanding, etc., but the scope of the present invention should not be construed limitedly.

The terms used in the present specification are only used to describe specific implementations or embodiments and are not intended to limit the present invention. The singular expression includes the plural expression unless the context clearly dictates otherwise. In the specification, terms “˜include,” “˜consist of,” etc. are intended to specify the presence of features, numbers, steps, operations, components, parts, or combinations thereof described in the specification. That is, it should be understood that terms “˜include,” “˜consist of,” etc. in the specification do not preclude the possibility of the presence or addition of one or more other features, numbers, steps, operations, components, parts or combinations thereof in advance.

Terms including ordinal numbers such as first or second may be used to describe various components, but the components are not limited by the terms. The terms are used only for the purpose of distinguishing one component from another.

When a first component is described as being “connected” or “coupled” to a second component, it should be understood that the first component may be directly connected or coupled to the second component or a third component may be present therebetween. On the other hand, when the first component is described as being “directly connected” or “directly coupled” to the second component, it should be understood that the third component is not present therebetween.

When a certain component is described as being “above” or “under” another component, it should be understood that the certain component may be disposed directly above another component and other components may also be present therebetween.

Unless defined otherwise, all terms used herein, including technical or scientific terms, have the same meaning as commonly understood by those of ordinary skill in the art to which the present invention pertains. Terms such as those defined in a commonly used dictionary should be construed as having a meaning consistent with the meaning in the context of the related art and should not be construed in an ideal or excessively formal meaning unless explicitly defined in the application.

In a state in which a cooking appliance is placed on a floor, a direction in which a door is installed with respect to the center of the cooking appliance is defined as a front side. Therefore, a direction in which the door is opened and food enters the cooking appliance becomes a rear side. For convenience, a direction facing the front and rear sides can be referred to as a first direction. Then, the front side may be one side in the first direction, and the rear side may be the other side in the first direction.

In addition, a direction of gravity can be defined as downward, and a direction opposite to the direction of gravity can be defined as upward.

In addition, when viewing the cooking appliance in a horizontal direction orthogonal to a front-rear direction of the cooking appliance, that is, at the front of the door of the cooking appliance, a width direction of the cooking appliance may be referred to as a left-right direction. For convenience, the left-right direction can be referred to as a second direction. Then, a right side can be referred to as one side in the second direction, and a left side can be referred to as the other side in the second direction.

In addition, the width direction of the cooking appliance may be referred to as a lateral direction. Then, the right side can be referred to as one side in the lateral direction, and the left side can be referred to as the other side in the lateral direction.

In addition, the above-described vertical direction can be referred to as a third direction. Then, an upper side can be referred to as one side in the third direction, and a lower side can be referred to as the other side in the third direction.

In addition, the above-described vertical direction can be referred to as a vertical direction. Then, the front-to-rear direction and the left-right direction, that is, the first direction and the second direction can be referred to as a horizontal direction.

Throughout the specification, when “A and/or B” is described, this means A, B, or A and B unless otherwise specified, and when “C to D” is described, this means C or more and D or less unless otherwise specified.

### First Embodiment

### [Overall Structure of the Cooking Appliance]

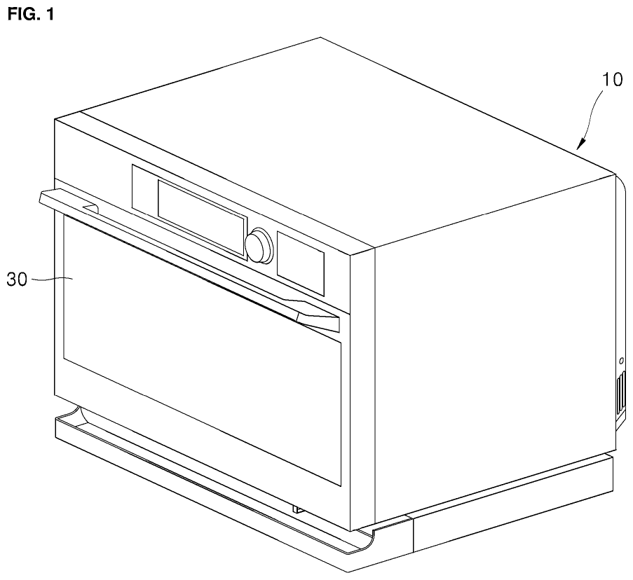

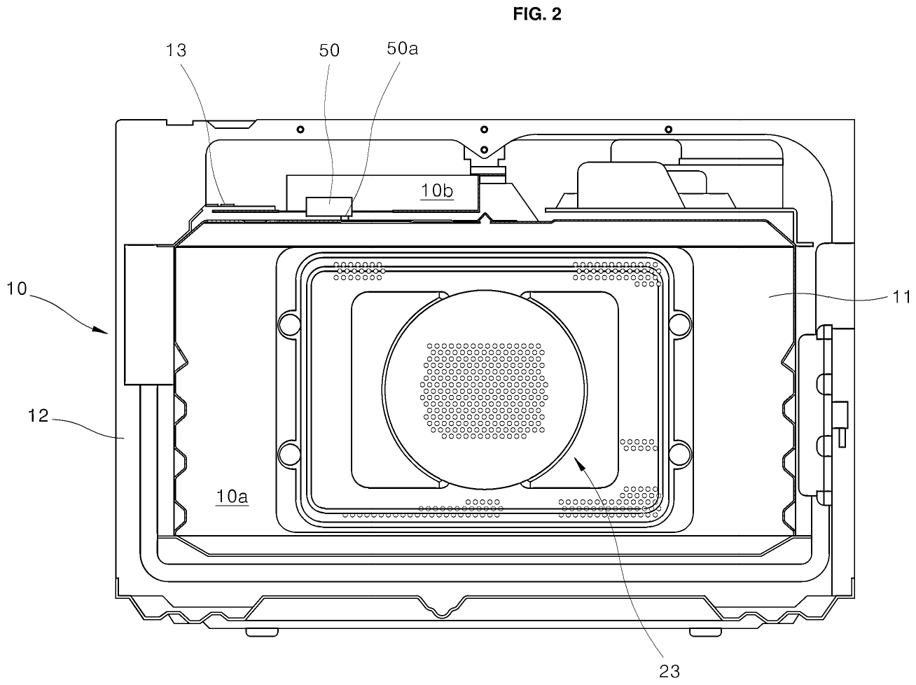

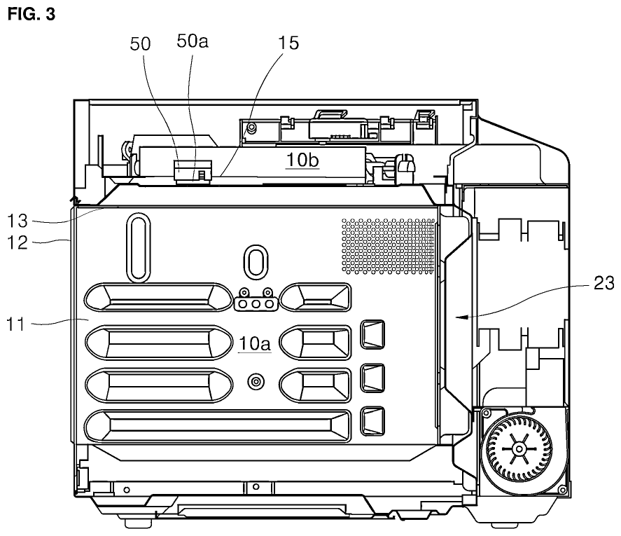

FIG. 1 is a perspective view showing a cooking appliance according to one embodiment of the present invention, FIG. 2 is a front cross-sectional view showing an internal structure of the cooking appliance shown in FIG. 1, and FIG. 3 is a side cross-sectional view showing the internal structure of the cooking appliance shown in FIG. 1.

Referring to FIGS. 1 to 3, the appearance of the cooking appliance may be formed by a main body 10. The main body 10 may be provided in a form including a substantially rectangular parallelepiped shape and formed of a material having a predetermined strength to protect a number of components installed in an internal space.

The main body 10 includes a cavity 11 that forms the skeleton of the main body 10. The cavity 11 may be formed in a hexahedral shape having an open front surface, and a cooking chamber 10a is provided inside the cavity 11.

The cavity 11 may be formed in the hexahedral shape having the open front surface, and the cooking chamber 10a may be formed inside the cavity 11. That is, the cooking chamber 10a may be formed as a space of a substantially hexahedral shape disposed inside the cavity 11 and formed as a space open forward.

In a state in which the cooking chamber 10a is shielded, food may be cooked while the inside of the cooking chamber 10a is heated. That is, in the cooking appliance of the present embodiment provided as the closed cooking appliance, the cooking chamber 10a is a space in which food is actually cooked.

The cooking appliance may be provided with a rotatable door 30 for selectively opening and closing the cooking chamber 10a. As an example, the door 30 may be provided in a form that opens and closes the cooking chamber 10a in a pull-down manner in which an upper end vertically rotates about a lower end thereof.

An electronic element chamber 10b may be provided outside the cavity 11, more specifically, above the cavity 11. The electronic element chamber 10b may be disposed above the cavity 11 and behind a control panel. A space in which electrical components are installed may be formed inside the electronic element chamber 10b.

A lower boundary surface of the electronic element chamber 10b may be specified by an upper panel 15 disposed above the cavity 11. The upper panel 15 may be disposed to block a space between the cavity 11 and the electronic element chamber 10b. The upper panel 15 may be disposed above the cavity 11 to specify the lower boundary surface of the electronic element chamber 10b.

A front surface of the electronic element chamber 10b may be shielded by a front panel 12. The front panel 12 may be disposed between the cavity 11 and the door 30 and may form a front surface of the main body 10. At least a portion of the front panel 12 may be disposed to block the front of the electronic element chamber 10b.

For example, an upper area of the front panel 12 disposed above the cooking chamber 10a may shield the front surface of the electronic element chamber 10b. The front panel 12 may protrude to an upper portion of the cavity 11 to specify a front boundary surface of the electronic element chamber 10b.

### [Heating Unit]

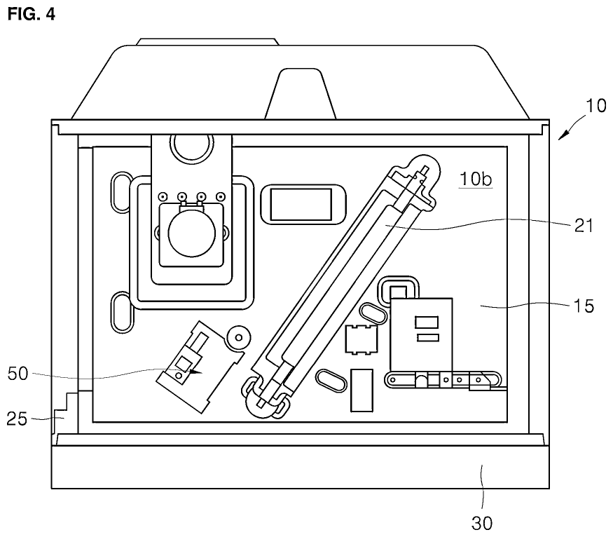

FIG. 4 is a plan cross-sectional view showing the internal structure of the cooking appliance shown in FIG. 1.

As shown in FIGS. 2 to 4, the cooking appliance is provided with a heating unit for heating the cooking chamber 10a. The heating unit may include a magnetron 25 capable of generating high frequencies. The magnetron 25 may receive a high-voltage current from a high-voltage transformer and supply a high frequency heat source to the inside of the cooking chamber 10a.

The magnetron 25 may be installed inside the main body 10 and disposed at the top or side of the cooking chamber 10a. In the present embodiment, it is shown that the magnetron 25 is disposed in the electronic element chamber 10b and disposed at a location biased to the side in the electronic element chamber 10b.

In addition, the heating unit may further include a grill heater 21 and a convection device 23. According to the present embodiment, the grill heater 21 may be provided above the cooking chamber 10a, and the convection device 23 may be provided behind the cooking chamber 10a.

The grill heater 21 may heat an internal space of the cooking chamber 10a at the top. In addition, the convection device 23 may suction and heat the air inside the cooking chamber 10a, and then discharges the air to the internal space of the cooking chamber 10a to flow the air so that the internal space of the cooking chamber 10a may be heated uniformly.

The grill heater 21 may heat the inside of the cooking chamber 10a at the top of the cooking chamber 10a. That is, the grill heater 21 is provided to directly apply heat to a cooking object at the top of the cooking chamber 10a.

The convection device 23 may be disposed behind the cooking chamber 10a and installed on a back surface of the cavity 11. The convection device 23 may include a convection cover installed on the back surface of the cooking chamber, a convection heater installed in the internal space of the convection, and a convection fan.

### [Structure of a Camera]

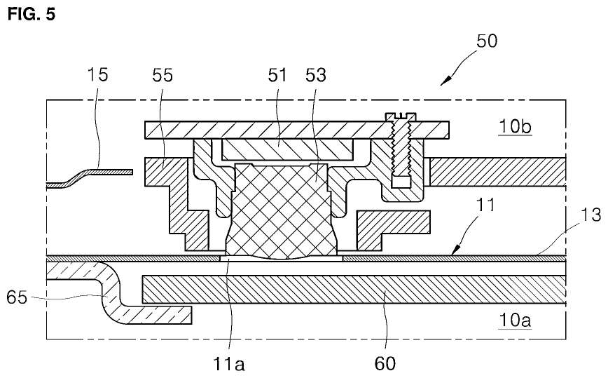

FIG. 5 is a front cross-sectional view showing an installation structure of a camera module according to one embodiment of the present invention.

Referring to FIGS. 2 to 5, the cooking appliance may include a camera 50. The camera 50 is disposed outside the cooking chamber 10a and the cavity 11 and provided to capture an image of the cooking chamber 10a. As an example, the camera 50 may be disposed above the cavity 11.

The camera 50 may include an image processing unit 51. The image processing unit 51 may include one or more image sensors. As the image sensor, CCD, CMOS, etc. may be used.

As an example, the image sensor may be provided in a form that is mounted on a circuit board. In this case, the image sensor may be disposed on a bottom surface of a circuit board facing an upper surface 13 of the cavity 11.

In addition, the camera 50 may include a lens unit 53. The lens unit 53 may include at least one lens. As an example, the lens unit 53 may be provided in a form in which a plurality of lenses disposed in a first direction are accommodated in a barrel.

The lens unit 53 may collect light reflected from a subject to form an optical image in an imaging area, and the image sensor may receive light incident through the lens unit 53 and convert the light into an image signal.

In addition, the camera 50 may further include various processors necessary to form an image based on the image signal output from the image sensor and further include a lighting composed of LEDs, etc.

The camera 50 may include a case 55. The case 55 may form the appearance of the camera 50, and various components constituting the camera 50, such as the image sensor, the lens unit 53, and the lighting, may be accommodated inside the case 55.

A through hole may be provided in a bottom surface of the case 55, and the through hole may vertically pass through the bottom surface of the case 55. The lens unit 53 may be exposed downward from the case 55 through the through hole.

In addition, the camera 50 may include a light receiving portion 50a. The light receiving portion 50a is a portion that allows light to pass through the camera 50. That is, light reflected from the subject may enter the camera 50 through the light receiving portion 50a, and the image sensor may receive the light entering the camera 50 and convert the light into the image signal.

As an example, the light receiving portion 50a may be defined as a concept including the through hole and the lens unit 53. In addition, the light receiving portion 50a may be defined as a concept including the through hole, the lens unit 53, and the image sensor. A lower end of the light receiving portion 50a may be disposed on the bottom surface of the case 55 and exposed downward from the bottom surface of the case 55.

A field of view of the camera 50 may be changed depending on a location of the light receiving portion 50a in the front-rear and left-right directions, and the viewing angle of the camera 50 may be changed depending on the size of the light receiving portion 50a. For example, as the location of the light receiving portion 50a is biased forward, the field of view of the camera 50 may also be changed to be biased forward, and as a diameter of the light receiving portion 50a increases, the field of view of the camera 50 may be expanded.

In addition, the field of view of the camera 50 may be changed depending on the size of the light receiving portion 50a. For example, as the diameter of the light receiving portion 50a increases, the field of view of the camera 50 may be expanded.

In addition, a direction the field of view of the camera 50 may be changed depending on a direction in which the light receiving portion 50a faces. For example, when the light receiving portion 50a faces downward, the field of view of the camera 50 also faces downward, and when the direction in which the light receiving portion 50a faces is changed to a direction between forward and downward, the field of view of the camera 50 may also be changed to the direction between forward and downward.

The camera 50 having the above configuration may be disposed above the cavity 11. As an example, the camera 50 may be disposed in a space between the cooking chamber 10a and the electronic element chamber 10b, that is, a space between the upper surface 13 of the cavity 11 and the upper panel 15. As another example, the camera 50 may be disposed in an upper space of the upper panel 15, that is, the electronic element chamber 10b.

In the present embodiment, it is shown that the camera 50 is disposed in the space between the upper surface 13 of the cavity 11 and the upper panel 15. In this case, the bottom surface of the case 55 may be disposed at a location facing the upper surface 13 of the cavity 11. In addition, the light receiving portion 50a may also be disposed at the location facing the upper surface 13 of the cavity 11.

The camera 50 disposed as described above may acquire an image related to the food accommodated in the cooking chamber 10a by capturing an image of the inside of the cooking chamber 10a at the top of the cooking chamber 10a.

As an example, the camera 50 may be installed on the upper panel 15. That is, the camera 50 may be disposed at a location spaced at a predetermined distance upward from the upper surface 13 of the cavity 11. The camera 50 may be disposed at a location spaced at a predetermined distance from the high-temperature cooking chamber 10a, that is, at a location at which the influence of heat transmitted from the cooking chamber 10a is less.

As another example, the camera 50 may be installed on the upper surface of the cavity 11. In this case, the camera 50 may be disposed at a location very close to an open hole H. In the camera 50 disposed as described above, not only the light receiving portion 50a may be disposed to face downward in the vertical direction, but also the light receiving portion 50a may be disposed to face a direction inclined from the vertical direction. That is, the camera 50 disposed very close to the open hole H may be disposed to be inclined toward the center of the cooking chamber 10a in a planar direction.

When the camera 50 is disposed at the location very close to the open hole H, a component for cooling the camera 50 may be installed near the camera 50. For example, a cooling fan may be installed near the camera 50, or an air guide for guiding the flow of cold air near the camera 50 may be installed near the camera 50.

In addition, the camera 50 may be disposed at a location biased forward in the front-rear direction and disposed at a location biased toward a lateral end in the lateral direction. For example, the camera may be disposed at a location close to a front left corner.

When a sheath heater type heater is provided on a ceiling surface of the cavity 11 inside the cooking chamber 10a, the above location is a location at which the influence of heat generated from the heater is less. Therefore, by arranging the camera 50 at the above location, the possibility of malfunction or damage to the camera 50 due to the heat generated from the heater can be reduced.

### [Structure Related to the Installation of the Camera]

The open hole H may be provided in the cavity 11. The open hole H may form a passage for allowing light to pass between the outside of the cavity 11 and the cooking chamber 10a. The open hole H may be formed to vertically pass through the upper surface 13 of the cavity 11.

The open hole H may be disposed between the light receiving portion 50a and the cooking chamber 10a. The light reflected from the subject inside the cooking chamber 10a may pass through the upper surface 13 of the cavity 11 through the open hole H. As described above, light emitted to the outside of the cavity 11 through the open hole H may enter the camera 50 through the light receiving portion 50a.

As an example, a diameter of the open hole H may be set to 8 to 12 mm. When the diameter of the open hole H is smaller than 8 mm, there may be a problem in which the field of view of the camera 50 cannot be properly secured, such as the structure near the open hole H blocking a portion of the field of view of the camera 50. In addition, considering that the maximum diameter of the open hole H for satisfying an allowable electromagnetic leakage value is 12 mm, when the diameter of the open hole H exceeds 12 mm, it can be seen that risk of electromagnetic leakage through the open hole H increases significantly.

In addition, the cooking appliance of the present embodiment may further include a transparent cover 60. The transparent cover 60 is provided to shield the open hole H. The transparent cover 60 is provided to block the movement of heat and allow light to pass through the same.

As an example, the transparent cover 60 may be made of a transparent heat-resistant glass material and installed on the upper surface 13 of the cavity 11 to cover the open hole H at the bottom. The transparent cover 60 may be provided in a form of a glass plate forming a horizontal plane and coupled to a lower side of the upper surface 13 of the cavity 11 by a bracket 65 installed at the lower side of the upper surface 13 of the cavity 11.

### [Operation and Effect of the Cooking Appliance]

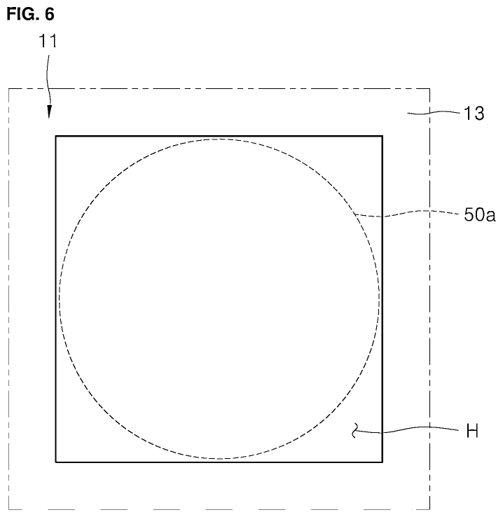

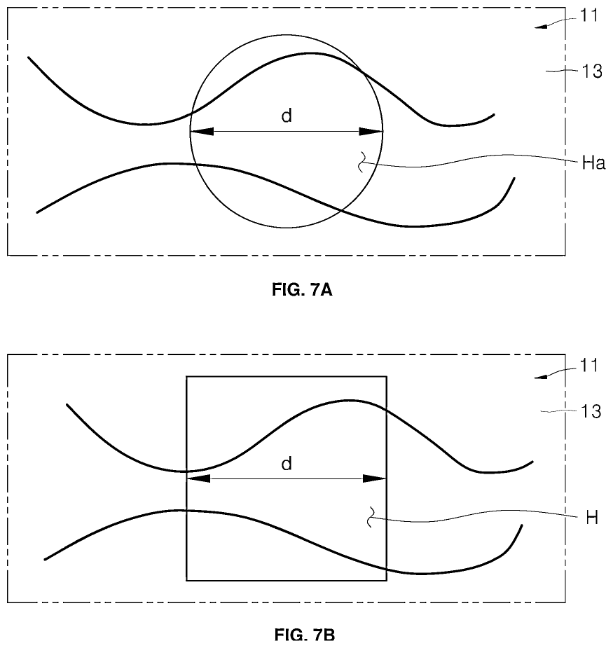

FIG. 6 is a plan view schematically showing a shape of an opening hole of the cooking appliance according to one embodiment of the present invention, and FIG. 7A-7B is a view for describing an operation of the opening hole of the cooking appliance according to one embodiment of the present invention.

Hereinafter, the operation and effect of the cooking appliance according to the present embodiment will be described with reference to FIGS. 2 to 7A-7B.

Referring to FIGS. 2 to 4, the cooking appliance according to the present embodiment may provide an automatic cooking function using the camera 50. The cooking appliance may acquire an image or video of the food accommodated inside the cooking chamber 10a using the camera 50.

According to the present embodiment, the light receiving portion 50a of the camera 50 may be disposed to face the open hole H. The light reflected from the subject inside the cooking chamber 10a may pass through the open hole H and enter the camera 50, and the camera 50 may capture the image projected through the open hole H.

The cooking appliance may determine the type and size of the food or determine the degree of cooking progress of the food by analyzing the food-related video or image acquired by the camera 50 for capturing the image of the inside of the cooking chamber 10a, and control the cooking operation of the cooking appliance based on the analyzed information.

For example, the cooking appliance may set the type, heating intensity, and heating time of heating unit that are suitable for cooking food whose size and type are identified based on the result of analysis of the image or video acquired by the camera 50. Then, the cooking appliance may control the operation of the heating unit so that cooking occurs at a set heating intensity and heating time.

When the heating unit operates to allow the cooking appliance to perform cooking using the high frequency heat source, the cooking appliance may operate the magnetron 25, and thus the magnetron 25 may receive a high voltage current from the high voltage transformer and supply the high frequency heat source to the inside of the cooking chamber 10a.

As described above, when the high frequency heat source is supplied to the inside of the cooking chamber 10a, the electromagnetic leakage through the open hole H may occur, and as the size of the open hole H increases, the risk of the electromagnetic leakage through the open hole H may increase.

Therefore, the size of the open hole H should be reduced to reduce the risk of electromagnetic leakage through the open hole H. However, as the size of the open hole H decreases, there is a problem that it is difficult to secure the field of view of the camera 50 and the field of view of the camera 50 decreases.

Considering such a point, as shown in FIGS. 5 and 6, the open hole H provided in the cooking appliance of the present embodiment may be formed in a polygonal shape. The open hole H may be disposed outside the light receiving portion 50a in a direction parallel to a planar surface perpendicular to the direction in which the open hole H passes, that is, in a horizontal direction.

As an example, the open hole H may be formed in a quadrangular shape forming a planar surface in the direction parallel to the planar surface perpendicular to the direction in which the open hole H passes, that is, the horizontal direction. Preferably, the open hole H may be formed in a square forming the planar surface in the horizontal direction.

For example, the open hole H may be formed in a circumscribed rectangle in contact with a circle or ellipse formed by the light receiving portion 50a. In the present embodiment, it is shown that the open hole H is formed in a square slightly greater than the circumscribed rectangle in contact with the circle formed by the light receiving portion 50a.

Equation below is for calculating a propagation loss according to the size of the open hole H.

$${T}_{d B} = 20 log ( \frac{3 λ}{2 π {d}^{3}} ) + \frac{32 {h}_{b}}{d}$$

T_{dB}: propagation loss (dB)
d: diameter of open hole
λ: wavelength of free space wave (122 mm@2.45 GHz)
hb: thickness of upper surface of cavity (mm)

Referring to Equation, it can be seen that as the diameter d of the open hole H increases, the propagation loss decreases. That is, as the diameter d of the open hole H increases, the amount of electromagnetic leakage may be increased.

To increase the field of view of the camera 50, the size of the open hole H should be increased, or the camera 50 should be in close contact with the open hole H as much as possible. However, as described above, as the diameter d of the open hole H increases, the possibility of electromagnetic leakage increases, and as a distance between the camera 50 and the open hole H decreases, the camera 50 approaches the cooking chamber 10a, and thus the possibility that the camera 50 is exposed to a high temperature increases.

That is, there is a problem that when the size of the open hole H increases, the risk of electromagnetic leakage is increased, and when the camera 50 approaches the open hole H, the camera 50 composed of components vulnerable to heat is exposed to a high temperature environment.

Considering such a point, in the present embodiment, the open hole H may be formed in a square forming the planar surface in the horizontal direction. The open hole H may be formed in a shape surrounding the light receiving portion 50a outside in the lateral direction in a top view. Preferably, the open hole H may be formed in a square slightly greater than the circumscribed square in contact with the circle formed by the light receiving portion 50a.

| | d [mm] | hb [mm] | T_{dB} [dB] |
|---|---|---|---|
| Comparative Example | 8 | 0.5 | −17 |
| Present embodiment | 8 | 0.5 | −17 |

According to Table, as shown in FIG. 7A, it is confirmed that a circular open hole Ha is formed in the upper surface 13 of the cavity 11 having the thickness of 0.5 mm, and when a diameter d of the circular open hole is 8 mm, the propagation loss measured in this case is about −17 dB (Comparative Example).

In comparison, as shown in FIG. 7B, it is confirmed that when the open hole H is formed in a square surrounding the light receiving portion 50a outside in the lateral direction and a length of a side of the open hole H is 8 mm that is equal to the diameter d of the circular open hole Ha, the propagation loss measured in this case is about −17 dB identically to Comparative Example (present embodiment).

The total area of the open hole H in the present embodiment is greater than an area of the open hole Ha exemplified in Comparative Example. The open hole H may form a passage necessary for light of the cooking chamber 10a to be incident on the light receiving portion 50a of the camera 50 and form a wider passage than the open hole Ha exemplified in Comparative Example.

Therefore, it is possible to effectively expand the field of view of the camera 50 provided to capture the cooking chamber 10a through the open hole H of the present embodiment.

That is, as in the present embodiment, when the open hole H is formed in a square surrounding the light receiving portion 50a outside in the lateral direction, it is possible to expand the field of view of the camera 50 without increasing the risk of electromagnetic leakage compared to the open hole Ha formed in a circular shape having the same diameter as the length of the side of the open hole H.

According to the cooking appliance of the present embodiment, it is possible to provide stable electromagnetic shielding performance even under the condition that the open hole H for capturing of the camera 50 is formed, thereby effectively performing automatic cooking using the camera 50 and cooking using the high frequency heat source at the same time.

In addition, according to the cooking appliance of the present embodiment, it is possible to provide stable electromagnetic shielding performance and expand the field of view of the camera 50, thereby more effectively capturing an image of large food or food located at the top of the cooking chamber.

### Second Embodiment

### [Structure of Shielding Protrusion]

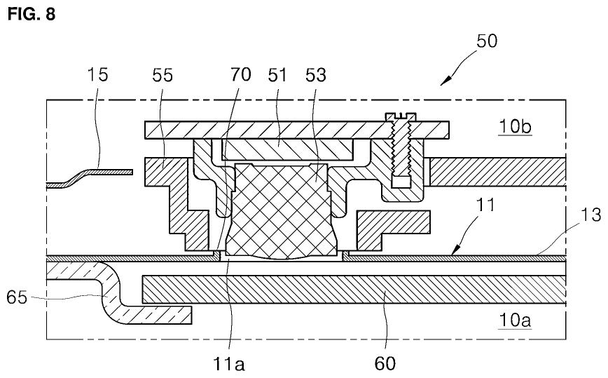

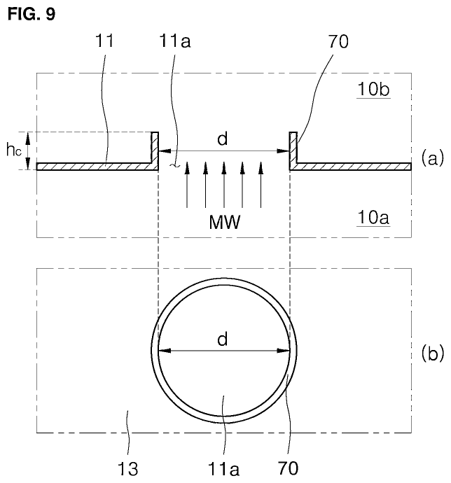

FIG. 8 is a front cross-sectional view showing an installation structure of a camera module according to another embodiment of the present invention, and FIG. 9 is a view for describing a structure of a shielding protrusion shown in FIG. 5.

Hereinafter, a structure and operation of a cooking appliance according to another embodiment of the present invention will be described with reference to FIGS. 8 and 9. Here, since the same reference numerals as in the previously shown drawings denote the same members performing the same functions, overlapping descriptions thereof will be omitted below.

Referring to FIG. 8, the cooking appliance of the present embodiment may include a shielding protrusion 70. The shielding protrusion 70 may be provided to protrude from the cavity 11.

The shielding protrusion 70 may be provided on the upper surface 13 of the cavity 11 and may surround the open hole 11a formed in the upper surface of the cavity 11 and protrude from the cavity 11. As an example, the shielding protrusion 70 may protrude from an inner circumferential surface of the upper surface 13 of the cavity 11 surrounding the open hole 11a in a direction in which the open hole 11a passes.

For example, the open hole 11a may be formed to pass through the upper surface of the cavity 11, and the shielding protrusion 70 may be formed to protrude the inner circumferential surface of the upper surface 13 of the cavity 11 surrounding the open hole 11a in the vertical direction.

In the present embodiment, it is shown that the open hole 11a is formed in a circular shape, and the shielding protrusion 70 surrounds the open hole 11a outside in the lateral direction and is formed to protrude upward from the upper surface 13 of the cavity 11. The shielding protrusion 70 may be provided in a circular pipe shape that surrounds the open hole 11a outside in the lateral direction and protrudes from the upper surface 13 of the cavity 11 in the vertical direction.

### [Operation and Effect of the Cooking Appliance]

FIG. 9 is a view for describing a structure of a shielding protrusion shown in FIG. 8.

Hereinafter, the operation and effect of the cooking appliance according to the present embodiment will be described with reference to FIGS. 3 and 4 and FIGS. 8 and 9.

Referring to FIGS. 3, 4, and 8, when the heating unit operates to allow the cooking appliance to perform the cooking using the high frequency heat source, the cooking appliance may operate the magnetron 25, and thus the magnetron 25 may receive the high voltage current from the high voltage transformer and supply the high frequency heat source to the inside of the cooking chamber 10a.

As described above, when the high frequency heat source is supplied to the inside of the cooking chamber 10a, the electromagnetic leakage through an open hole 11a may occur, and as the size of the open hole 11a increases, the risk of the electromagnetic leakage through the open hole 11a increases.

Therefore, the size of the open hole 11a should be reduced to reduce the risk of electromagnetic leakage through the open hole 11a. However, as the size of the open hole 11a decreases, there is a problem that it is difficult to secure the field of view of the camera 50 and the field of view of the camera 50 decreases.

Considering such a point, as shown in FIGS. 8 and 9, the cooking appliance of the present embodiment is provided with the shielding protrusion 70. The shielding protrusion 70 may be provided in the shape that surrounds the open hole 11a outside and protrudes upward from the open hole 11a.

Equation below is for calculating the propagation loss according to a height of the shielding protrusion 70.

$${T}_{d B} = 20 log ( \frac{3 λ}{2 π {d}^{3}} ) + \frac{32 {h}_{b}}{d}$$

T_{dB}: propagation loss (dB)
d: diameter of open hole
λ: wavelength of free space wave (122 mm@2.45 GHz)
hc: thickness of upper surface of cavity and height of shielding protrusion (mm)

Referring to Equation, it can be seen that as the height of the shielding protrusion 70 increases, the propagation loss increases. That is, as the height of the shielding protrusion 70 increases, the amount of the electromagnetic leakage can be reduced. Such a result can be confirmed through Table below.

| | d [mm] | hc [mm] | T_{dB} [dB] |
|---|---|---|---|
| Comparative Example | 8 | 0.5 | −17 |
| Present embodiment | 13 | 2.5 | −25 |

According to Table, when the diameter d of the open hole 11a formed in the upper surface 13 of the cavity 11 having the thickness of 0.5 mm is 8 mm, it is confirmed that the measured propagation loss is about −17 dB (Comparative Example).

In comparison, when the shielding protrusion 70 having the height of 2 mm is provided on the upper surface 13 of the cavity 11 having the thickness of 0.5 mm (present embodiment), the propagation loss measured at this time is measured as −25 dB even when the open hole 11a is formed in the diameter d greater than the open hole 11a in Comparative Example, for example, 13 mm.

That is, when the shielding protrusion 70 is provided on the upper surface 13 of the cavity 11 as in the present embodiment, even when the size of the open hole 11a is greater than that of Comparative Example, the possibility of the electromagnetic leakage may decrease compared to Comparative Example.

That is, by providing the shielding protrusion 70 on the upper surface 13 of the cavity 11 as in the present embodiment, the size of the open hole 11a can be increased while reducing the possibility of the electromagnetic leakage, thereby expanding the field of view of the camera 50.

According to the cooking appliance of the present embodiment, it is possible to provide stable electromagnetic shielding performance even under the condition that the open hole 11a for capturing of the camera 50 is formed, thereby effectively performing automatic cooking using the camera 50 and cooking using the high frequency heat source at the same time.

In addition, according to the cooking appliance of the present embodiment, it is possible to provide stable electromagnetic shielding performance and expand the field of view of the camera 50 by increasing the size of the open hole 11a, thereby more effectively capturing an image of large food or food located at the top of the cooking chamber.

The present invention has been described with reference to the embodiments shown in the accompanying drawings, but it is merely illustrative, and those skilled in the art to which the relevant technology pertains will understand that various modifications and other equivalent embodiments are possible therefrom. Therefore, the true technical scope of the present invention should be determined by the scope of the appended claims.

The present invention is directed to providing a cooking appliance with an improve structure, which can effectively perform automatic cooking using a camera for capturing an image of a cooking chamber and cooking using a high frequency heat source at the same time.

In addition, the present invention is directed to providing a cooking appliance with an improved structure, which can increase a viewing angle of a camera without increasing risk of electromagnetic leakage.

### Technical Solution

A cooking appliance according to one embodiment of the present invention for achieving the objects includes a camera disposed outside a cavity, wherein an open hole exposing a light receiving portion of the camera to the inside of a cooking chamber is formed in the cavity, and the open hole is formed in a polygonal shape or surrounded by a protrusion protruding from the cavity.

In addition, a cooking appliance according to another aspect of the present invention includes a camera disposed outside a cavity, wherein an open hole exposing a light receiving portion of the camera to the inside of a cooking chamber is formed in the cavity, and the open hole is formed in a polygonal shape.

In addition, a cooking appliance according to another aspect of the present invention includes a camera disposed outside a cavity, wherein a cavity includes an open hole exposing a light receiving portion of the camera to the inside of a cooking chamber and a shielding protrusion protruding from the cavity, and the shielding protrusion surrounds the open hole and protrudes from the cavity.

A cooking appliance according to one aspect of the present invention may include a cavity having a cooking chamber formed therein, and a camera disposed outside the cavity.

In addition, it is preferable that the camera includes a light receiving portion configured to allow light to pass through the inside of the camera.

In addition, it is preferable that the cavity is formed with an open hole exposing the light receiving portion to the inside of the cooking chamber.

In addition, it is preferable that the open hole is formed in a polygonal shape.

In addition, it is preferable that the open hole is formed to pass through the cavity.

In addition, the open hole is disposed outside the light receiving portion in a direction parallel to a planar surface perpendicular to a direction in which the open hole passes.

In addition, it is preferable that the open hole is formed in a quadrangular shape forming a planar surface parallel to the planar shape perpendicular to the direction in which the open hole passes.

In addition, it is preferable that the open hole is formed in a square forming a planar surface parallel to the planar shape perpendicular to the direction in which the open hole passes.

In addition, it is preferable that the open hole is formed in a circumscribed square in contact with a circle or oval formed by the light receiving portion.

In addition, the cooking appliance according to the present invention may further include a magnetron configured to supply a high frequency heat source to the inside of the cooking chamber.

A cooking appliance according to another aspect of the present invention may include a cavity having a cooking chamber formed therein, a camera disposed outside the cavity, and a shielding protrusion protruding from the cavity.

In addition, it is preferable that the cavity is formed with an open hole exposing the light receiving portion to the inside of the cooking chamber.

In addition, it is preferable that the shielding protrusion surrounds the open hole and protrudes from the cavity.

In addition, it is preferable that the shielding protrusion protrudes from an inner circumferential surface of the cavity surrounding the open hole in a direction in which the open hole passes.

In addition, it is preferable that the camera is disposed above the cavity.

In addition, it is preferable that the open hole is formed to vertically pass through the upper surface of the cavity.

In addition, it is preferable that the shielding protrusion vertically protrudes from an inner circumferential surface of the cavity surrounding the open hole.

In addition, it is preferable that the shielding protrusion protrudes upward from the cavity.

In addition, the cooking appliance according to the present invention may further include a transparent cover covering the open hole and coupled to the cavity.

In addition, it is preferable that the transparent cover is disposed under the open hole, and the shielding protrusion protrudes upward from an inner circumferential surface of the cavity surrounding the open hole.

### Advantageous Effects

The cooking appliance according to the present invention can effectively perform automatic cooking using the camera and cooking using the high frequency heat source at the same time by providing stable electromagnetic shielding performance even in the condition that the open hole for capturing of the camera is formed.

In addition, according to the present invention, by expanding the viewing angle of the camera while providing the stable electromagnetic shielding performance, it is possible to more effectively capture large food or food located at the top of the cooking chamber.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### DESCRIPTION OF REFERENCE NUMERALS

10: main body
10a: cooking chamber
10b: electronic element chamber
11: cavity
11a: open hole
12: upper surface
13: front panel
15: upper panel
21: grill heater
23: convection device
25: magnetron
30: door
50: camera
50a: light receiving portion
51: image processing unit
53: lens unit
55: case
60: transparent cover
65: bracket
70: shielding protrusion

What is claimed is:

1. A cooking appliance comprising:
a cavity having a cooking chamber disposed inside the cavity; and
a camera disposed outside the cavity,
wherein the camera includes a light receiving portion configured to allow light to pass into an inside of the camera,
the cavity includes a surface having a cavity hole configured to expose the light receiving portion to an inside of the cooking chamber, and
the cavity hole is formed to have a polygonal shape, or the cavity hole is surrounded by a protrusion that protrudes from the cavity.

2. The cooking appliance of claim 1, wherein the cavity hole is formed to pass through the surface of the cavity in a first direction from the cooking chamber toward the camera.

3. The cooking appliance of claim 2, wherein the cavity hole is disposed outside the light receiving portion in a second direction parallel to a planar surface of the cavity hole, the second direction perpendicular to the first direction in which the cavity hole passes through the cavity.

4. The cooking appliance of claim 3, wherein the cavity hole is formed to have a quadrangular shape at the planar surface.

5. The cooking appliance of claim 3, wherein the cavity hole is formed to have a square shape at the planar surface.

6. The cooking appliance of claim 3, wherein the cavity hole is formed to have a circumscribed square shape and configured to contact a circle or an oval portion of the light receiving portion.

7. The cooking appliance of claim 1, comprising a shielding protrusion that surrounds the cavity hole and protrudes from the cavity.

8. The cooking appliance of claim 7, wherein the cavity hole is disposed to pass through the surface of the cavity in a first direction from the cooking chamber toward the camera, and
the shielding protrusion protrudes, in the first direction, from an inner circumferential surface of the cavity surrounding the cavity hole.

9. The cooking appliance of claim 7, wherein the camera is disposed above the cavity,
the cavity hole is formed to vertically pass through an upper surface of the cavity, and
the shielding protrusion vertically protrudes from an inner circumferential surface of the cavity that surrounds the cavity hole.

10. The cooking appliance of claim 7, comprising a transparent cover coupled to the cavity and disposed to cover the cavity hole such that the transparent cover is between the cooking chamber and the cavity hole.

11. The cooking appliance of claim 1, comprising a magnetron configured to supply a high frequency heat source to the cooking chamber.

12. A cooking appliance comprising:
a cavity having a cooking chamber; and
a camera that includes a case and a lens unit disposed outside the cooking chamber, a bottom surface of the case having a case hole that faces the cooking chamber such that light from the cooking chamber is to pass through the case hole to the lens unit,
wherein a planar surface of the cavity has a cavity hole that exposes light from the inside of the cooking chamber through the case hole to the lens unit, and
the cavity hole is to have a polygonal shape on the planar surface of the cavity.

13. The cooking appliance of claim 12, wherein the cavity hole is open in a first direction from the cooking chamber toward the lens unit such that the light is to pass through the cavity hole in the first direction.

14. The cooking appliance of claim 13, wherein the cavity hole is disposed outside the case hole in a second direction parallel to the planar surface of the cavity hole, the second direction is perpendicular to the first direction.

15. The cooking appliance of claim 14, wherein the cavity hole is to have a quadrangular shape at the planar surface, and a planar front area of the cavity hole is larger than a planar front area of the case hole.

16. The cooking appliance of claim 14, wherein the cavity hole is to have a square shape at the planar surface, and a planar front area of the cavity hole is larger than a planar front area of the case hole.

17. The cooking appliance of claim 12, wherein the cavity hole is to have a circumscribed square shape configured to contact a circle or an oval portion of the case hole.

18. A cooking appliance comprising:
a cavity having a cooking chamber;
a camera disposed outside the cavity; and
a shielding protrusion that protrudes from the cavity,
wherein the camera includes a light receiving portion configured to allow light to pass through an inside of the camera,
a surface of the cavity is to have a cavity hole that exposes the cooking chamber to the light receiving portion, and
wherein the shielding protrusion protrudes from the cavity and surrounds at least part of the cavity hole.

19. The cooking appliance of claim 18, wherein the cavity hole is disposed to pass through the surface of the cavity in a first direction from the cooking chamber toward the light receiving portion, and
the shielding protrusion protrudes, in the first direction, from an inner circumferential surface of the cavity surrounding the cavity hole.

20. The cooking appliance of claim 18, wherein the camera is disposed above the cavity,
the cavity hole is formed to vertically pass through an upper surface of the cavity, and
the shielding protrusion vertically protrudes from an inner circumferential surface of the cavity so as to surround part of the cavity hole.
